(19) United States
(12) Patent Application Publication
(10) Pub. No.: US 2019/0362016 A1
(43) Pub. Date: Nov. 28, 2019

(54) FREQUENT PATTERN ANALYSIS FOR DISTRIBUTED SYSTEMS

(71) Applicant: salesforce.com, inc., San Francisco, CA (US)

(72) Inventors: Kexin Xie, San Mateo, CA (US); Yacov Salomon, Danville, CA (US)

(21) Appl. No.: 16/119,955

(22) Filed: Aug. 31, 2018

Related U.S. Application Data
(60) Provisional application No. 62/676,526, filed on May 25, 2018.

(51) Int. Cl. G06F 17/30

(52) U.S. Cl. CPC G06F 17/30598; G06F 17/30961; G06F 2216/03; G06F 17/30539; G06F 17/30958

(57) ABSTRACT

Methods, systems, and devices supporting frequent pattern (FP) analysis for distributed systems are described. Some database systems may analyze data sets to determine FPs within the data. However, because FP mining relies on combinatorics, very large data sets incur combinatorial explosion of the memory and processing resources needed to handle the FP analysis. To obtain the resources needed for FP analysis of large data sets, the database system may spin up multiple data processing machines and may distribute the FP mining process across these machines. The database system may distribute the data set according to a tradeoff between commonality and data attribute list length, efficiently utilizing the resources at each data processing machine. This may result in data subsets with either large numbers of data objects or large numbers of data attributes for data objects, but not both, limiting the combinatorial explosion and, correspondingly, limiting the resources required.

CROSS REFERENCES

The present Application for Patent claims priority to U.S. Provisional Patent Application No. 62/676,526 by Xie et al., entitled “Frequent Pattern Analysis for Distributed Systems,” filed May 25, 2018, which is assigned to the assignee hereof and expressly incorporated by reference herein.

### FIELD OF TECHNOLOGY

The present disclosure relates generally to database systems and data processing, and more specifically to frequent pattern (FP) analysis for distributed systems.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cases, the cloud platform may support frequent pattern (FP) analysis for data sets. For example, a data processing machine may determine FPs based on data in a database or data indicated by a user device. However, performing FP analysis on very large data sets may be extremely costly in memory resources, processing resources, processing latency, or some combination of these. This problem may be especially prevalent when tracking activity data for users or user devices of a system. For example, data sets generated based on this data may include thousands of users or user devices, where each user or user device may be associated with thousands of data attributes corresponding to different activities or activity parameters. Because FP analysis deals with combinatorics between the data objects (e.g., the users) and the data attributes (e.g., the activities), this large length and breadth of the data set results in a huge memory and processing overhead at the data processing machine.

### BRIEF DESCRIPTION OF THE DRAWINGS

FIG. 1 illustrates an example of a system for frequent pattern (FP) analysis at a database system that supports FP analysis for distributed systems in accordance with aspects of the present disclosure.

FIG. 2 illustrates an example of a database system implementing an FP analysis procedure that supports FP analysis for distributed systems in accordance with aspects of the present disclosure.

FIG. 3 illustrates an example of a database system implementing a distributed FP analysis procedure in accordance with aspects of the present disclosure.

FIG. 4 illustrates an example of a process flow that supports FP analysis for distributed systems in accordance with aspects of the present disclosure.

FIG. 5 shows a block diagram of an apparatus that supports FP analysis for distributed systems in accordance with aspects of the present disclosure.

FIG. 6 shows a block diagram of a distribution module that supports FP analysis for distributed systems in accordance with aspects of the present disclosure.

FIG. 7 shows a diagram of a system including a device that supports FP analysis for distributed systems in accordance with aspects of the present disclosure.

FIG. 8 shows a flowchart illustrating methods that support FP analysis for distributed systems in accordance with aspects of the present disclosure.

### DETAILED DESCRIPTION

Some database systems may perform frequent pattern (FP) analysis on data sets to determine common and interesting patterns within the data. These interesting patterns may be useful to users for many customer relationship management (CRM) operations, such as marketing analysis or sales tracking. In some cases, a database system may automatically determine FPs for one or more data sets based on a configuration of the database system. In other cases, the database system may receive a command from a user device (e.g., based on a user input at the user device) to determine FPs for a data set. The database system may determine the FPs within a data set using one or more FP mining techniques. For example, for improved efficiency of the system and for a shorter latency in determining the patterns, the database system may transform the data set into a condensed data structure including an FP-tree and a linked list and may use an FP-growth model to derive the FPs. This condensed data structure may support faster FP mining than the original data set (e.g., a data set stored as a relational database table) can support, as well as faster querying of the determined patterns. For example, because the database system—or, more specifically, a data processing machine (e.g., a bare-metal machine, virtual machine, or container) at the database system—can generate the condensed data structure with just two passes through a data set, and because determining the FPs from the condensed data structure may be on a scale of approximately one to two orders of magnitude faster than determining the FPs from the original data, the database system may significantly improve the latency involved in deriving the FPs and the corresponding patterns of interest. Furthermore, if these FPs are stored and processed locally at a data processing machine, the latency involved in querying for the patterns (e.g., by a user device for processing or display) may be greatly reduced, as the data processing machine may handle the query locally without having to hit a database of the database system.

However, generating and locally storing a full FP-tree, as well as a complete set of FPs mined from the FP-tree, may use a large amount of memory and processing resources at the data processing machine. In some cases, the data processing machine may not contain enough available memory or processing resources to handle this FP analysis procedure, especially for very large data sets (e.g., data sets containing information related to web browser activities or other activities performed by users or user devices). To handle large data sets, the database system may distribute the FP analysis procedure across a number of data processing machines. Each data processing machine may receive a subset of the data and may separately transform the subsets into efficient data structures (e.g., local FP-trees and linked lists) for FP analysis. The machines may then separately perform FP mining on these locally stored data structures. The amount of data sent to each data processing machine may be based on the available resources identified for that specific data processing machine.

To efficiently utilize the resources at the data processing machines, the database system may distribute the data set to limit the combinations between the data objects and the data attributes of the data subsets. For example, if both the number of data objects and the number of data attributes for these data objects are large (e.g., greater than some threshold value(s)), the FP analysis may experience combinatorial explosion, greatly increasing the memory and processing resources needed to handle the FP analysis of the data. The database system may instead group the data into data subsets according to the distribution of the data, such that each data subset can either exceed a certain dynamic or pre-determined threshold number of data objects or exceed a certain dynamic or pre-determined threshold number of data attributes, but not both. In this way, the database system may divide the data set into data subsets in such a way to limit the combinatorics within each data subset. This technique may allow for efficient use of the resources at each data processing machine, improving the latency and reducing the overhead of the FP mining procedure.

Aspects of the disclosure are initially described in the context of an environment supporting an on-demand database service. Additional aspects of the disclosure are described with reference to database systems and process flows. Aspects of the disclosure are further illustrated by and described with reference to apparatus diagrams, system diagrams, and flowcharts that relate to FP analysis for distributed systems.

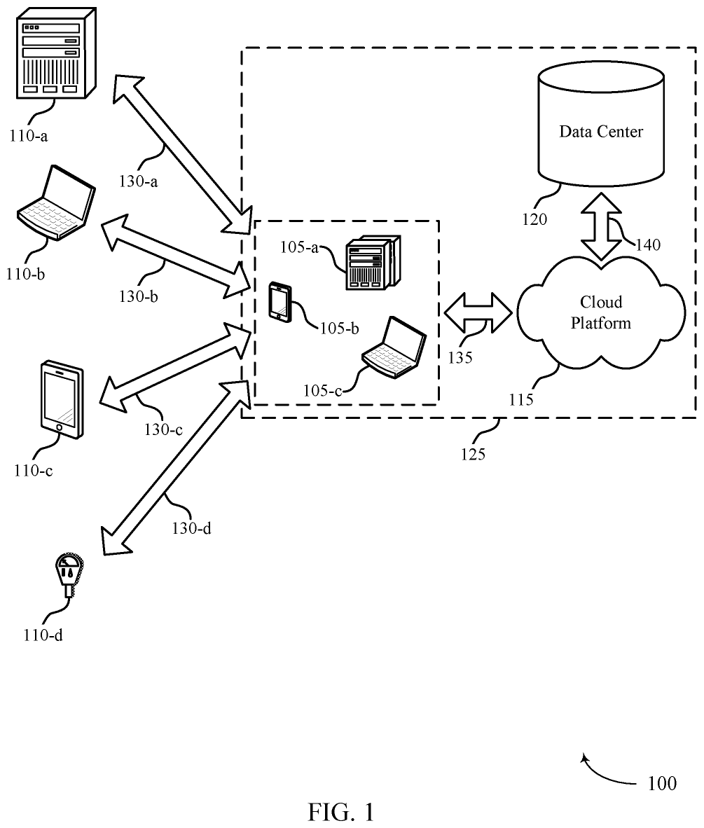

FIG. 1 illustrates an example of a system 100 for cloud computing that supports FP analysis for distributed systems in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

Some data centers 120 may perform FP analysis on data sets to determine common and interesting patterns within the data. In some cases, a data center 120 may automatically determine FPs for one or more data sets based on a configuration of the data center 120. In other cases, the data center 120 may receive a command from a cloud client 105 (e.g., based on a user input to the cloud client 105) to determine FPs for a data set. The data center 120 may determine the FPs within a data set using one or more FP mining techniques. For example, for improved efficiency of the system and for a shorter latency in determining the patterns, the data center 120 may transform the data set into a condensed data structure including an FP-tree and a linked list and may use an FP-growth model to derive the FPs. This condensed data structure may support faster FP mining than the original data set supports (e.g., a data set stored as a relational database table), and may also support faster querying of the determined patterns. For example, because the data center 120—or, more specifically, a data processing machine (e.g., a bare-metal machine, virtual machine, or container) at the data center 120—can generate the condensed data structure with just two passes through the data set, and because determining the FPs from the condensed data structure is on a scale of approximately one to two orders of magnitude faster than determining the FPs from the original data set, the data center 120 may significantly improve the latency involved in deriving the FPs and patterns of interest. Furthermore, if these FPs are stored and processed locally at the data processing machine, a querying latency for retrieving the patterns (e.g., by a cloud client 105 for processing or display) may be greatly reduced, as the data processing machine may handle the query locally without having to hit the database.

However, generating and locally storing a full FP-tree, as well as a complete set of FPs mined from the FP-tree, may use a large amount of memory and processing resources at the data processing machine. In some cases, the data processing machine may not contain enough available memory or processing resources to handle this FP analysis procedure, especially for very large data sets. For example, data sets containing information related to activities performed by users or user devices in a system or for a tenant may include thousands or millions of data objects (e.g., user devices) and thousands or millions of data attributes (e.g., web activities) for each of those data objects, resulting in a very large data set for FP mining. To handle such large data sets, the data center 120 may distribute the FP analysis procedure across a number of data processing machines. Each data processing machine may receive a subset of the data and may separately transform the subsets into efficient data structures for FP analysis. The machines may then separately perform FP mining on these locally stored data structures. The amount of data sent to each data processing machine may be based on the available resources supported by that specific data processing machine.

To efficiently utilize the resources at the data processing machines, the data center 120 may distribute the data set to limit the combinations between the data objects and the data attributes of the data subsets. For example, if both the number of data objects and the number of data attributes for one or more of these data objects are large, the FP analysis may experience combinatorial explosion, greatly increasing the memory and processing overhead associated with handling the FP analysis of this data. The data center 120 may instead group the data into data subsets according to the distribution of the data, such that each data subset can exceed either a threshold number of data objects or a threshold number of data attributes, but not both. In this way, the data center 120 may divide the data set into data subsets that limit the combinatorics within each data subset. This technique may allow for efficient use of the resources at each data processing machine, improving the latency and reducing the overhead of the FP mining procedure. By limiting the processing and memory resources used to handle the FP analysis procedure at the data processing machines, the data center 120 may minimize or reduce the number of data processing machines needed to analyze the large data set.

In some conventional systems, FP mining may be performed at a single data processing machine, which may limit the size of the data sets that the database system may analyze for patterns. In other conventional systems, the transformed data for FP mining or the results of an FP mining procedure may be stored external to a data processing machine to support a larger memory capacity. However, storing the data external to the data processing machine incurs a latency hit when querying for the data, as the data processing machine hits the external data storage with a retrieval request each time the data processing machines loads FP information for analysis.

In contrast, the system 100 supports a database system (e.g., data center 120) that may distribute the FP mining across multiple data processing machines. This distribution procedure may support handling of very large data sets as well as horizontal scaling techniques in cases where data sets continue to grow in size (e.g., due to ongoing user or user device activities in the system 100). Furthermore, locally storing the FP analysis results at the data processing machines may significantly reduce the latency involved in deriving and retrieving the patterns locally (e.g., as opposed to deriving or retrieving the patterns from a data source external to the machines), making FP analysis for the very large data sets feasible. Furthermore, the database system utilizes an efficient distribution technique to limit the memory and processing overhead at each data processing machine. For example, by distributing the data in data subsets utilizing a tradeoff between commonality and attribute list length, the database system may limit the combinatorial explosion at each individual data processing machine. This may reduce the number of data processing machines and reduce the amount of resources at each data processing machine needed to derive, store, and serve the data patterns.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

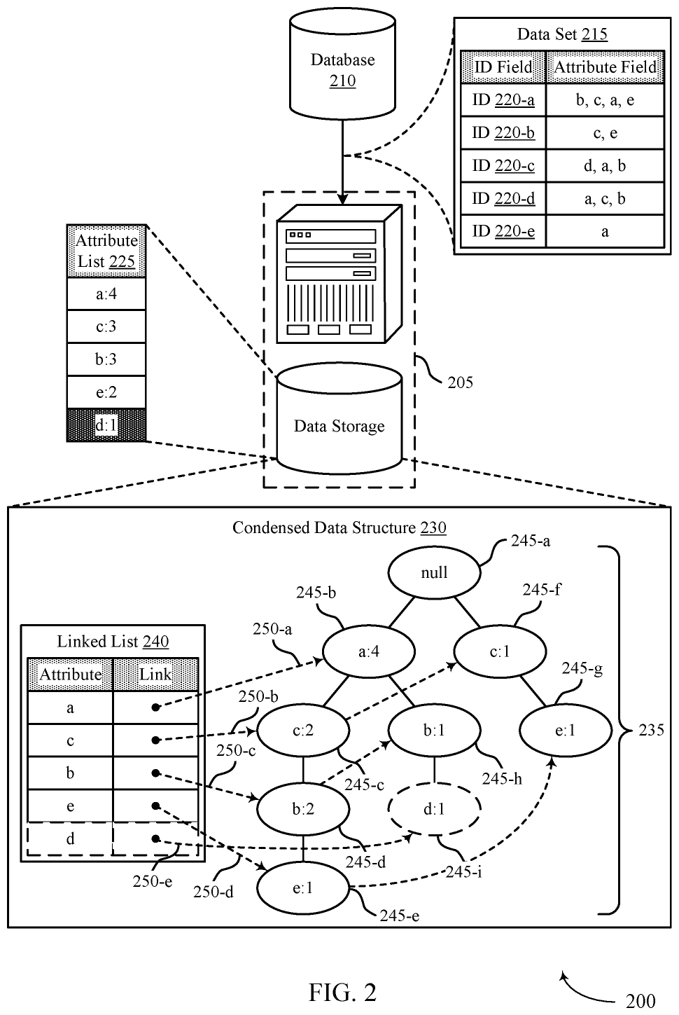

FIG. 2 illustrates an example of a database system 200 implementing an FP analysis procedure that supports FP analysis for distributed systems in accordance with aspects of the present disclosure. The database system 200 may be an example of a data center 120 as described with reference to FIG. 1, and may include a database 210 and a data processing machine 205. In some cases, the database 210 may be an example of a transactional database, a time-series database, a multi-tenant database, or some combination of these or other types of databases. The data processing machine 205 may be an example of a database server, an application server, a server cluster, a virtual machine, a container, or some combination of these or other hardware or software components supporting data processing for the database system 200. The data processing machine 205 may include a processing component and a local data storage component, where the local data storage component supports the memory resources of the data processing machine 205 and may be an example of a magnetic tape, magnetic disk, optical disc, flash memory, main memory (e.g., random-access memory (RAM)), memory cache, cloud storage system, or combination thereof. The data processing machine 205 may perform an FP analysis on a data set 215 (e.g., based on a user input command or automatically based on a configuration of the database system 200 or a supported FP-based application).

As described herein, the database system 200 may implement an FP-growth model for pattern mining that utilizes a condensed data structure 230. The condensed data structure 230 may include an FP-tree 235 and a linked list 240 linked to the nodes 245 of the FP-tree 235 via links 250. However, it is to be understood that the database system 200 may alternatively use other FP analysis techniques and data structures than those described. For example, the database system 200 may use a candidate set generation-and-test technique, a tree projection technique, or any combination of these or other FP analysis techniques. In other cases, the database system 200 may perform an FP analysis procedure similar to the one described herein but containing fewer, additional, or alternative processes to those described. The distribution processes described may be implemented with the FP-growth technique and the condensed data structure 230, or with any other FP analysis technique or data structure.

The data processing machine 205 may receive a data set 215 for processing. For example, the database 210 may transmit the data set 215 to the data processing machine 205 for FP analysis. The data set 215 may include multiple data objects, where each data object includes an identifier (ID) 220 and a set of data attributes. The data set 215 may include all data objects in the database 210, or may include data objects associated with a certain tenant (e.g., if the database 210 is a multi-tenant database), with a certain time period (e.g., if the attributes are associated with events or activities with corresponding timestamps), or with some other subset of data objects based on a user input value. For example, in some cases, a user operating a user device may select one or more parameters for the data set 215, and the user device may transmit the parameters to the database 210 (e.g., via a database or application server). The database 210 may transmit the data set 215 to the data processing machine 205 based on the received user input.

Each data object in the data set 215 may be identified based on an ID 220 and may be associated with one or more data attributes. These data attributes may be unique to that data object or may be common across multiple data objects. In some cases, an ID 220 may be an example of a text string unique to that data object. For example, if the data objects correspond to users in the database system 200, the IDs 220 may be user identification numbers, usernames, social security numbers, or some other similar form of ID where each value is unique to a user. The data attributes may be examples of activities performed by a data object (e.g., a user) or characteristics of the data object. For example, the data attributes may include information related to user devices operated by a user (e.g., internet protocol (IP) addresses, a total number of devices operated, etc.), information related to activities performed by the user while operating one of the user devices (e.g., web search histories, software application information, email communications, etc.), information related specifically to the user (e.g., information from a user profile, values or scores associated with the user, etc.), or a combination thereof. As illustrated in FIG. 2, these different data attributes may be represented by different letters (e.g., attributes {a}, {b}, {c}, {d}, and {e}).

In the exemplary case illustrated, the data set 215 may include five data objects. The first data object with ID 220-a may include data attributes {b, c, a, e}, the second data object with ID 220-b may include data attributes {c, e}, the third data object with ID 220-c may include data attributes {d, a, b}, the fourth data object with ID 220-d may include data attributes {a, c, b}, and the fifth data object with ID 220-e may include data attribute {a}. In one example, each data object may correspond to a different user or user device, and each data attribute may correspond to an activity or activity parameter performed by the user or user device. For example, attribute {a} may correspond to a user making a particular purchase online, while attribute {b} may correspond to a user visiting a particular website in a web browser of a user device. These data attributes may be binary values (e.g., Booleans) related to characteristics of a user.

The data processing machine 205 may receive the data set 215, and may construct a condensed data structure 230 based on the data set 215. The construction process may involve two passes through the data set 215, where the data processing machine 205 processes the data attributes for each data object in the data set 215 during each pass. In a first pass through the data set 215, the data processing machine 205 may generate an attribute list 225. The attribute list 225 may include the data attributes contained in the data set 215, along with their corresponding supports (i.e., occurrence frequencies within the data set 215). In some cases, during this first pass, the data processing machine 205 may filter out one or more attributes based on the supports for the attributes and a minimum support threshold, In these cases, the resulting data attributes included in the attribute list 225 may be referred to as frequent items or frequent attributes. The data processing machine 205 may order the data attributes in the attribute list 225 in descending order of support. For example, as illustrated, data processing machine 205 may identify that attribute {a} occurs four times in the data set 215, attributes {c} and {b} occur three times, attribute {e} occurs two times, and attribute {d} occurs one time. If the minimum support threshold, is equal to two, the data processing machine 205 may remove {d} from the attribute list 225 (or otherwise not include {d} in the attribute list 225) because the support for attribute {d} is less than the minimum support threshold. In some cases, a user may specify the minimum support threshold, using input features of a user interface. The data processing machine 205 may store the attribute list 225 in memory (e.g., temporary memory or persistent memory).

In a second pass through the data set 215, the data processing machine 205 may generate the condensed data structure 230 for efficient FP mining, where the condensed data structure 230 includes an FP-tree 235 and a linked list 240. The data processing machine 205 may generate a root node 245-a for the FP-tree 235, and may label the root node 245-a with a “null” value. Then, for each data object in the data set 215, the data processing machine 205 may order the attribute fields according to the order of the attribute list 225 (e.g., in descending order of support) and may add or update a branch of the FP-tree 235. For example, the data processing machine 205 may order the data attributes for the first data object with ID 220-a in order of descending support {a, c, b, e}. As no child nodes 245 exist in the FP-tree 235, the data processing machine 205 may create new child nodes 245 representing this ordered set of data attributes. The node for the first attribute in the ordered set is created as a child node 245-b of the root node 245-a, the node for the second attribute is created as a further child node 245-c off of this child node 245-b, and so on. For example, the data processing machine may create node 245-b for attribute {a}, node 245-c for attribute {c}, node 245-d for attribute {b}, and node 245-e for attribute {e} based on the order of descending support. When creating a new node 245 in the FP-tree 235, the data processing machine 205 may additionally set the count for the node 245 to one (e.g., indicating the one instance of the data attribute represented by the node 245).

The data processing machine 205 may then process the second data object with ID 220-b. The data processing machine 205 may order the data attributes as {c, e} (e.g., based on the descending order of support as determined in the attribute list 225), and may check the FP-tree 235 for any nodes 245 stemming from the root node 245-a that correspond to this pattern. As the first data attribute of this ordered set is {c}, and the root node 245-a does not have a child node 245 for {c}, the data processing machine 205 may create a new child node 245-f from the root node 245-a for attribute {c} and with a count of one. Further, the data processing machine 205 may create a child node 245-g off of this {c} node 245-f, where node 245-g represents attribute {e} and is set with a count of one.

As a next step in the process, the data processing machine 205 may order the attributes for the data object with ID 220-c as {a, b, d} and may add this ordered set to the FP-tree 235. In some cases, if data attribute {d} does not have a significantly large enough support value (e.g., as compared to the minimum support threshold, the data processing machine 205 may ignore the {d} data attribute (and any other data attributes that are not classified as “frequent” attributes) in the list of attributes for the data object. In either case, the data processing machine 205 may check the FP-tree 235 for any nodes 245 stemming from the root node 245-a that correspond to this ordered set. Because child node 245-b for attribute {a} stems from the root node 245-a, and the first attribute in the ordered set for the data object with ID 220-c is {a}, the data processing machine 205 may determine to increment the count for node 245-b rather than create a new node 245. For example, the data processing machine 205 may change node 245-b to indicate attribute {a} with a count of two. As the only child node 245 off of node 245-b is child node 245-c for attribute {c}, and the next attribute in the ordered set for the data object with ID 220-c is attribute {b}, the data processing machine 205 may generate a new child node 245-h off of node 245-b that corresponds to attribute {b} and may assign the node 245-h a count of one. If attribute {d} is included in the attribute list 225, the data processing machine 205 may additionally create child node 245-i for {d}.

This process may continue for each data object in the data set 215. For example, in the case illustrated, the data object with ID 220-d may increment the counts for nodes 245-b, 245-c, and 245-d, and the data object with ID 220-e may increment the count for node 245-b. Once the attributes—or the frequent attributes, when implementing a minimum support threshold—from each data object in the data set 215 are represented in the FP-tree 235, the FP-tree 235 may be complete in memory of the data processing machine 205 (e.g., stored in local memory for efficient processing and FP mining, or stored externally for improved memory capacity). By generating the ordered attribute list 225 in the first pass through the data set 215, the data processing machine 205 may minimize the number of branches needed to represent the data, as the most frequent data attributes are included closest to the root node 245-a. This may support efficient storage of the FP-tree 235 in memory. Additionally, generating the attribute list 225 allows the data processing machine 205 to identify infrequent attributes and remove these infrequent attributes when creating the FP-tree 235 based on the data set 215.

In addition to the FP-tree 235, the condensed data structure 230 may include a linked list 240. The linked list 240 may include all of the attributes from the attribute list 225 (e.g., all of the attributes in the data set 215, or all of the frequent attributes in the data set 215), and each attribute may correspond to a link 250. Within the table, these links 250 may be examples of head of node-links, where the node links point to one or more nodes 245 of the FP-tree 235 in sequence or in parallel. For example, the entry in the linked list 240 for attribute {a} may be linked to each node 245 in the FP-tree 235 for attribute {a} via link 250-a (e.g., in this case, attribute {a} is linked to node 245-b). If there are multiple nodes 245 in the FP-tree 235 for a specific attribute, the nodes 245 may be linked in sequence. For example, attribute {c} of the linked list 240 may be linked to nodes 245-c and 245-f in sequence via link 250-b. Similarly, link 250-c may link attribute {b} of the linked list 240 to nodes 245-d and 245-h, link 250-d may link attribute {e} to nodes 245-e and 245-g, and—if frequent enough to be included in the attribute list 225—link 250-e may link attribute {d} to node 245-i.

In some cases, the data processing machine 205 may construct the linked list 240 following completion of the FP-tree 235. In other cases, the data processing machine 205 may construct the linked list 240 and the FP-tree 235 simultaneously, or may update the linked list 240 after adding each data object representation from the data set 215 to the FP-tree 235. The data processing machine 205 may also store the linked list 240 in memory along with the FP-tree 235. In some cases, the linked list 240 may be referred to as a header table (e.g., as the “head” of the node-links are located in this table). Together, these two structures form the condensed data structure 230 for efficient FP mining at the data processing machine 205. The condensed data structure 230 may contain all information relevant to FP mining from the data set 215 (e.g., for a minimum support threshold, ξ). In this way, transforming the data set 215 into the FP-tree 235 and corresponding linked list 240 may support complete and compact FP mining.

The data processing machine 205 may perform a pattern growth method, FP-growth, to efficiently mine FPs from the information compressed in the condensed data structure 230. In some cases, the data processing machine 205 may determine the complete set of FPs for the data set 215. In other cases, the data processing machine 205 may receive a data attribute of interest (e.g., based on a user input in a user interface), and may determine all patterns for that data attribute. In yet other cases, the data processing machine 205 may determine a single “most interesting” pattern for a data attribute or a data set 215. The “most interesting” pattern may correspond to the FP with the highest occurrence rate, the longest list of data attributes, or some combination of a high occurrence rate and long list of data attributes. For example, the “most interesting” pattern may correspond to the FP with a number of data attributes greater than an attribute threshold with the highest occurrence rate, or the “most interesting” pattern may be determined based on a formula or table indicating a tradeoff between occurrence rate and length of the attribute list.

To determine all of the patterns for a data attribute, the data processing machine 205 may start from the head of a link 250 and follow the node link 250 to each of the nodes 245 for that attribute. The FPs may be defined based on a minimum support threshold, which may be the same minimum support threshold as used to construct the condensed data structure 230. For example, ξ=2, a pattern is only considered “frequent” if it appears two or more times in the data set 215. To identify the complete set of FPs for the data set 215, the data processing machine 205 may perform the mining procedure on the attributes in the linked list 240 in ascending order. As attribute {d} does not pass the minimum support threshold of ξ=2, the data processing machine 205 may initiate the FP-growth method with data attribute {e}.

To determine the FPs for data attribute {e}, the data processing machine 205 may follow link 250-d for attribute {e}, and may identify node 245-e and node 245-g both corresponding to attribute {e}. The data processing machine 205 may identify that data attribute {e} occurs two times in the FP-tree 235 (e.g., based on summing the count values for the identified nodes 245-e and 245-g), and thus has at least the simplest FP of (e:2) (i.e., a pattern including attribute {e} occurs twice in the data set 215). The data processing machine 205 may determine the paths to the identified nodes 245, {a, c, b, e} and {c, e}. Each of these paths occurs once in the FP-tree 235. For example, even though node 245-b for attribute {a} has a count of four, this attribute {a} appears together with attribute {e} only once (e.g., as indicated by the count of one for node 245-e). These identified patterns may indicate the path prefixes for attribute {e}, namely {a:1, c:1, b:1} and {c:1}. Together, these path prefixes may be referred to as the sub-pattern base or the conditional pattern base for data attribute {e}. Using the determined conditional pattern base, the data processing machine 205 may construct a conditional FP-tree for attribute {e}. That is, the data processing machine 205 may construct an FP-tree using similar techniques as those described above, where the FP-tree includes only the attribute combinations that include attribute {e}. Based on the minimum support threshold, and the identified path prefixes {a:1, c:1, b:1} and {c:1}, only data attribute {c} may pass the support check. Accordingly, the conditional FP-tree for data attribute {e} may contain a single branch, where the root node 245 has a single child node 245 for attribute {c} with a count of two (e.g., as both of the path prefixes include attribute {c}). Based on this conditional tree, the data processing machine 205 may derive the FP (ce:2). That is, the attributes {c} and {e} occur together twice in the data set 215, while attribute {e} does not occur at least two times in data set 215 with any other data attribute. For conditional FP-trees with greater than one child node 245, the data processing machine 205 may implement a recursive mining process to determine all eligible FPs that contain the attribute being examined. The data processing machine 205 may return the FPs (e:2) and (ce:2) for the data attribute {e}. In some cases, the data processing machine 205 may not count patterns that simply contain the data attribute being examined as FPs, and, in these cases, may just return (ce:2).

This FP-growth procedure may continue with attribute {b}, then attribute {c}, and conclude with attribute {a}. For each data attribute, the data processing machine 205 may construct a conditional FP-tree. Additionally, because the FP-growth procedure is performed in an ascending order through the linked list 240, the data processing machine 205 may ignore child nodes 245 of the linked nodes 245 when determining the FPs. For example, for attribute {b}, the link 250-c may indicate nodes 245-d and 245-h. When identifying the paths for {b}, the data processing machine 205 may not traverse the FP-tree 235 past the linked nodes 245-d or 245-h, as any patterns for the nodes 245 below this on the tree were already determined in a previous step. For example, the data processing machine 205 may ignore node 245-e when determining the patterns for node 245-d, as the patterns including node 245-e were previously derived. Based on the FP-growth procedure and these conditional FP-trees, the data processing machine 205 may identify additional FPs for the rest of the data attributes in the linked list 240. For example, using a recursive mining process and based on the minimum support threshold of ξ=2, the data processing machine 205 may determine the complete set of FPs: (e:2), (ce:2), (b:3), (cb:2), (ab:3), (acb:2), (c:3), (ac:2), and (a:4).

In some cases, the data processing machine 205 may store the resulting patterns locally in a local data storage component. Additionally or alternatively, the data processing machine 205 may transmit the patterns resulting from the FP analysis to the database 210 for storage or to a user device (e.g., for further processing or to display in a user interface). In some cases, the data processing machine 205 may determine a “most interesting” FP (e.g., (acb:2) based on the number of data attributes included in the pattern) and may transmit an indication of the “most interesting” FP to the user device. In other cases, the user device may transmit an indication of an attribute for examination (e.g., data attribute {c}), and the data processing machine 205 may return one or more of the FPs including data attribute {c} in response.

By transforming the data set 215 into the condensed data structure 230, the data processing machine 205 may avoid the need for generating and testing a large number of candidate patterns, which can be very costly in terms of processing and memory resources, as well as in terms of time. For very large database systems 200, databases 210, or data sets 215, the FP-tree 235 may be much smaller than the size of the data set 215, and the conditional FP-trees may be even smaller. For example, transforming a large data set 215 into an FP-tree 235 may shrink the data by a factor of approximately one hundred, and transforming the FP-tree 235 into a conditional FP-tree may again shrink the data by a factor of approximately one hundred, resulting in very condensed data structures 230 for FP mining.

In some cases, the FP analysis procedure may support additional techniques for improved FP analysis or data handling. For example, the database system 200 may support techniques for distributed systems, differential support, epsilon (ε)-closure, or a combination thereof. In some cases, the data set 215 may be too large for a single data processing machine 205. For example, the condensed data structure 230 resulting from the data set 215 may not fit in the memory of the data processing machine 205, or the FP sets returned by the FP analysis procedure on the condensed data structure 230 may be too large for processing at the data processing machine 205. Accordingly, the database system 200 may spin up multiple data processing machines 205 and distribute the data set 215 across the different data processing machines 205. The granularity of the distribution may allow for each data processing machine 205 to handle the amount of data assigned to it. In some cases, the distribution may be based on the number of data attributes for each data object, available memory resource capabilities for the data processing machines 205, or both. Each data processing machine 205 may create a local condensed data structure 230 from the received subset of data, and may remove the subsets of data from memory once the condensed data structures 230 are successfully stored. Removing the data subsets may increase the available memory at the data processing machines 205 for other features or processes.

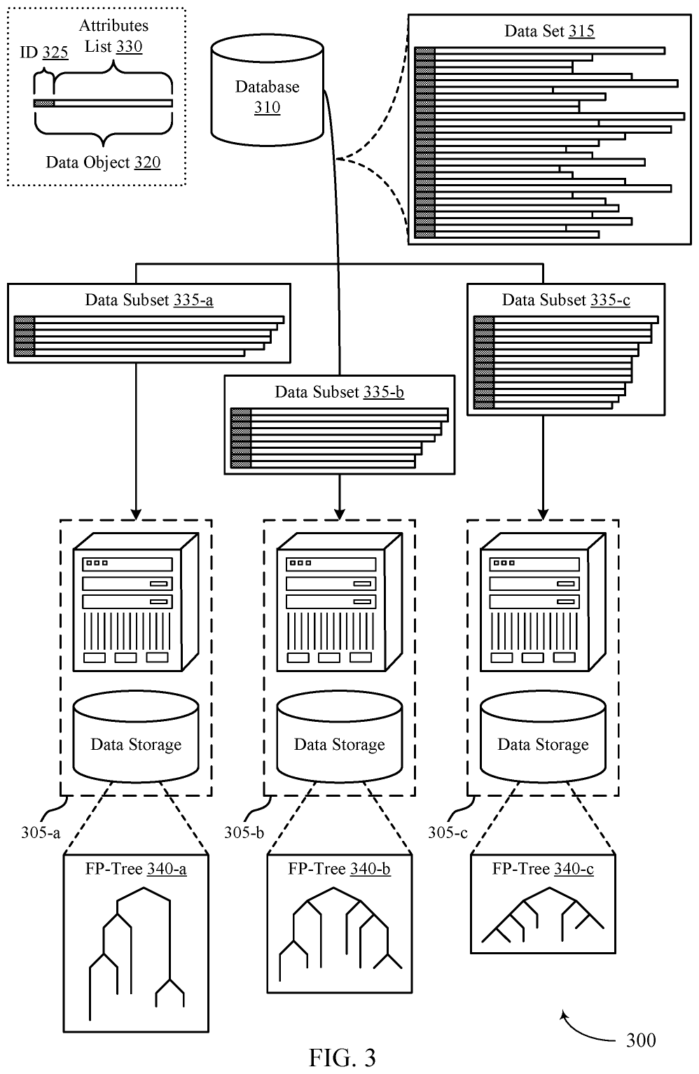

FIG. 3 illustrates an example of a database system 300 implementing a distributed FP analysis procedure in accordance with aspects of the present disclosure. The database system 300 may be an example of a database system 200 or a data center 120 as described with reference to FIGS. 1 and 2. The database system 300 may include multiple data processing machines 305 (e.g., data processing machine 305-a, data processing machine 305-b, and data processing machine 305-c), which may be examples of the data processing machine 205 as described with reference to FIG. 2. Additionally, the database system 300 may include a database 310, which may be an example of a database 210, and may be served by the data processing machines 305. Each data processing machine 305 in the database system 300 may operate independently and may include separate data storage components. If the database system 300 receives or retrieves a data set 315 for FP analysis that is too large for processing or memory storage at a single data processing machine 305, the database 310 may distribute the data set 315 across multiple data processing machines 305 for FP analysis. In order to efficiently utilize the processing and memory resources of each data processing machine 305, the database system 300 may implement specific techniques for distributing the data set 315.

For example, the database system 300 may receive a data set 315 from the database 310. The data set 315 may contain a number of data objects 320, where each data object includes an ID 325 and a data attribute list 330. In one example, the data objects may be examples of users or user devices with corresponding user IDs, and the data attributes may be examples of activities with certain properties performed by the user or characteristics associated with the user. In some cases, the data attributes may be referred to as “items.”

The database system 300 may determine an approximate size for the data set 315. For example, the database system 300 may store algorithms or lookup tables to estimate the memory and/or processing resources needed to store condensed data structures associated with the data set 315 and FP mine these condensed data structures. The actual size may be based on combinatorics within the data set 315 (e.g., between the data objects 320 and the attributes from the data attribute lists 330). The resources needed for these combinatorics may increase greatly based on the length (e.g., the length of the attribute lists 330) and the breadth (e.g., the number of data objects 320) of the data set 315. However, to limit the combinatorics involved relative to the amount of data, the database system 300 may limit one of these parameters of the data set 315. For example, a data set with relatively great length but not breadth or a data set with relatively great breadth but not length may efficiently utilize memory and processing resources.

The database system 300 may distribute the data set 315 into a number of data subsets 335 based on the available resources in data processing machines 305. For example, the database system 300 may spin up a number of data processing machines 305 to handle the approximate or exact size of the data set 315 between them. For example, the database system 300 may spin up three data processing machines 305 (e.g., data processing machines 305-a, 305-b, and 305-c) for FP analysis handling, and may accordingly group the data objects 320 of the data set 315 into three data subsets 335-a, 335-b, and 335-c. In some cases, the database system 300 may determine the available memory and/or processing capacities for the data processing machines 305. The database system 300 may estimate the capacities for the machines or may receive indications of the capacities from the data processing machines 305. In some cases, different data processing machines 305 may have different amounts of available resources (e.g., based on the type of machine, the other processes running on the machine, what data is already stored at the machine, etc.). The database system 300 may form the data subsets 335 according to the specific memory and/or processing thresholds for each data processing machine 305.

The database system 300 may perform the grouping of the data objects 320 based on the distribution of the data objects 320. For example, in general, data attributes that are more common may usually be parts of shorter attribute lists 330, while data attributes that are more rare may usually be parts of longer attribute lists 330. The database system 300 may group the data objects 320 according to this principle. For example, the database system 300 may iteratively form groups of data objects with increasingly more common data attributes. In this way, the database system 300 may generate data subset 335-a with rarer data attributes, data subset 335-b with relatively more common data attributes, and data subset 335-c with the most common data attributes. These data subsets 335 may be transmitted to the corresponding data processing machines 305 for processing. Additionally or alternatively, the database system 300 may perform the grouping of the data objects 320 based on other distribution techniques. For example, the database system 300 may sort the data objects 320 into different data subsets 335 based on attribute list 330 lengths. In other examples, the database system 300 may sort the data objects 320 into different data subsets 335 based on specific sorting parameters for the data objects 320 or based on the data object IDs 325.

Each data processing machine 305 may perform its own data compaction and FP analysis. For example, data processing machine 305-a may generate an FP-tree 340-a (and corresponding linked list) based on data subset 335-a independent of the other data processing machines 305 and data subsets 335. Similarly, data processing machine 305-b may generate FP-tree 340-b based on data subset 335-b and data processing machine 305-c may generate FP-tree 340-c based on data subset 335-c. In this way, rather than generate full FP-tree for FP-growth processing, the database system 300 may distribute the work across a number of data processing machines 305 such that the FP-trees 340 and the FP analysis results may fit in memory and support processing. By grouping the data objects 320 by commonality or length of attribute lists, and by varying the number of data objects in each data subset 335, the data processing machines 305 may efficiently perform the combinatorics on the data subsets 335 without exceeding the memory or processing capabilities of the data processing machines 305. Furthermore, if the data objects 320 are sorted into data subsets 335—and, correspondingly, data processing machines 305—based on the commonality of one or more data attributes in each data object 320, data objects 320 with similar data attributes may be likely to be grouped into the same data subset 335. Accordingly, the distributed FP mining may identify a large percentage of the FPs in the initial data set 315 (e.g., above a certain acceptable threshold) while efficiently using the resources of multiple data processing machines 305.

A user device may query the database system 300 for information related to the FP analysis. For example, the user device may request the “most interesting” FP or a set of FPs related to a specific data attribute or data object. In some cases, the data processing machines 305 may store the FP mining results locally. In these cases, the database system 300 may query each of the data processing machines 305 used for the FP analysis for the requested pattern(s). Alternatively, the database system 300 may determine a database processing machine 305 that received a data attribute of interest in its data subset 335 and may query the determined database processing machine 305 for the pattern(s). In other cases, the data processing machines 305 may transmit identified FPs to the database 310 for storage. In these cases, the user query may be processed centrally at the database 310, and the database may transmit the requested FP(s) in response to the query message received from the user device. The user device may display the query results in a user interface, may display specific information related to the one or more retrieved FPs in the user interface, may perform data processing or analytics on the retrieved FPs, or may perform some combination of these actions.

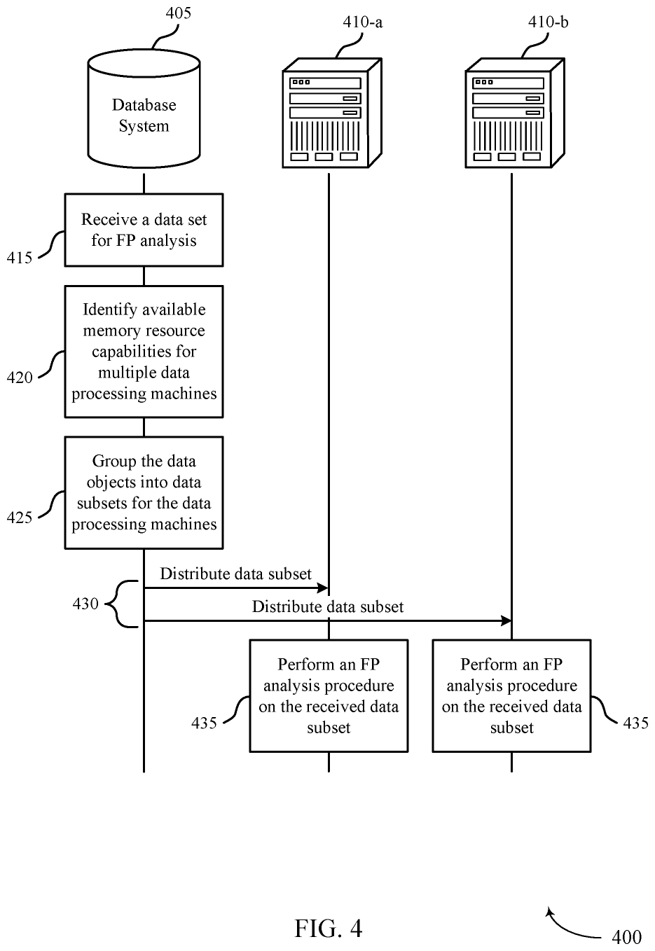

FIG. 4 illustrates an example of a process flow 400 that supports FP analysis for distributed systems in accordance with aspects of the present disclosure. The process flow 400 may include a database system 405 and multiple data processing machines 410 (e.g., data processing machine 410-a and data processing machine 410-b), which may be examples of virtual machines, containers, or bare-metal machines. These may be examples of the corresponding devices described with reference to FIGS. 1 through 3. In some cases, the data processing machines 410 may be components of the database system 405. During an FP analysis, the database system 405 may distribute data between the data processing machines 410-a and 410-b to efficiently utilize the available memory and processing resources. In some cases, the database system 405 may distribute data to additional data processing machines 410 depending on the amount of data for processing and the available memory resources at the data processing machines. In some implementations, the processes described herein may be performed in a different order or may include one or more additional or alternative processes performed by the devices.

At 415, the database system 405 may receive a data set for FP analysis. In some cases, the database system 405 may retrieve the data set from a database (e.g., based on a user input, an application running on a data processing machine 410, or a configuration of the database system 405). This data set may contain multiple data objects, where each data object includes a number of data attributes. Each data object may additionally include an ID. In some cases, the data objects may correspond to users or user devices, and the data attributes may correspond to activities performed by the users or user devices, parameters of activities performed by the users or user devices, or characteristics of the users or user devices. In one specific example, the database system 405 may perform a pseudo-realtime FP analysis procedure. In this example, the database system 405 may periodically or aperiodically receive updated data sets for FP analysis (e.g., once a day, once a week, etc.). These updated data sets may include new data objects, new data attributes, or both. For example, the new data attributes may correspond to activities performed by users in the time interval since the last data set was received in the pseudo-realtime FP analysis procedure.

At 420, the database system 405 may identify available memory resource capabilities for a set of data processing machines 410 (e.g., data processing machines 410-a and 410-b) in or associated with the database system 405. In some cases, the database system 405 may additionally identify processing capabilities for the set of data processing machines 410. The database system 405 may identify the memory and/or processing capabilities of the data processing machines 410 by transmitting resource capability requests to the data processing machines 410 or by estimating the resource capabilities of the data processing machines 410. In some examples, identifying the available memory resources may involve identifying machine-specific memory resources for each of the data processing machines 410. In some cases, based on an initial determination of the available memory resources, the database system 405 may spin up one or more additional data processing machines 410 to handle the size of the data set for FP analysis.

At 425, the database system 405 may group the data objects of the data set into multiple data subsets, where the grouping is based on the number of data attributes for each of the data objects and the identified available memory resource capabilities. The database system 405 may form a number of data subsets equal to the number of data processing machines 410, where each data subset is sized so that it can fit in memory and be processed by a specific data processing machine 410 of the set of data processing machines 410. The database system 405 may construct data subsets that are potentially large in either the number of attributes for the data objects or the number of data objects in the subset, but not both. In this way, the database system 405 may limit the combinatorics within each data subset, reducing the processing and memory cost associated with performing FP analysis on each data subset. In one example, the database system 405 may group the data objects such that each data subset includes a number of data objects that is less than a data object threshold or a number of data attributes for each data object of the subset that is less than a data attribute threshold. By using one of these two thresholds for forming data subsets—but not necessarily both—the database system 405 may limit the combinatorics between objects and attributes associated with each subset. In another example, the database system 405 may implement a series of attribute commonality thresholds, a series of attribute list length thresholds, a series of data subset size thresholds, or some combination of these to determine data subsets for multiple data processing machines 410.

At 430, the database system 405 may distribute the data objects of the data set to the multiple data processing machines 410 according to the data subsets. For example, the database system 405 may transmit a first data subset to data processing machine 410-a and a second data subset to data processing machine 410-b. These data subsets may be specifically distributed to data processing machines 410 to not exceed memory or processing limitations of the machines.

At 435, the data processing machines 410 may separately perform FP analysis procedures on the received data subsets. For example, data processing machine 410-a may perform an FP analysis procedure on the first data subset, and data processing machine 410-b may perform an FP analysis procedure on the second data subset. This FP analysis procedure may involve each data processing machine 410 generating a condensed data structure including an FP-tree and a linked list for the data subset corresponding to that specific data processing machine 410 and storing the condensed data structure locally in memory or in external memory storage associated with the data processing machine 410. These condensed data structures may be used for FP analysis by the data processing machines 410. In this way, the database system 405 may efficiently utilize the memory and processing resources for multiple data processing machines 410 while distributing the FP analysis work across the multiple different machines.

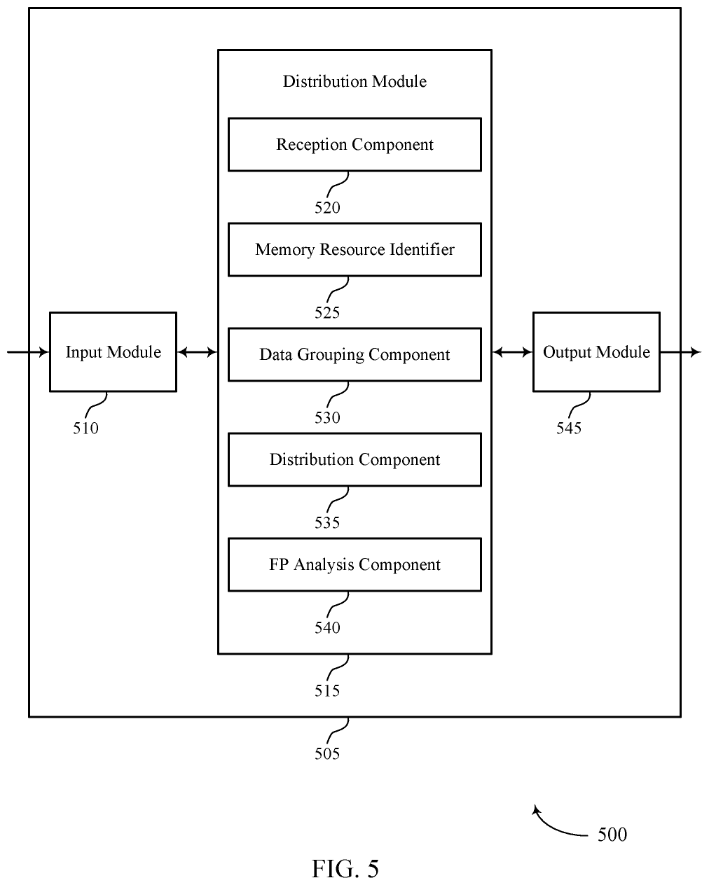

FIG. 5 shows a block diagram 500 of an apparatus 505 that supports FP analysis for distributed systems in accordance with aspects of the present disclosure. The apparatus 505 may include an input module 510, a distribution module 515, and an output module 545. The apparatus 505 may also include a processor. Each of these components may be in communication with one another (e.g., via one or more buses). In some cases, the apparatus 505 may be an example of a user terminal, a database server, or a system containing multiple computing devices, such as a database system with distributed data processing machines.

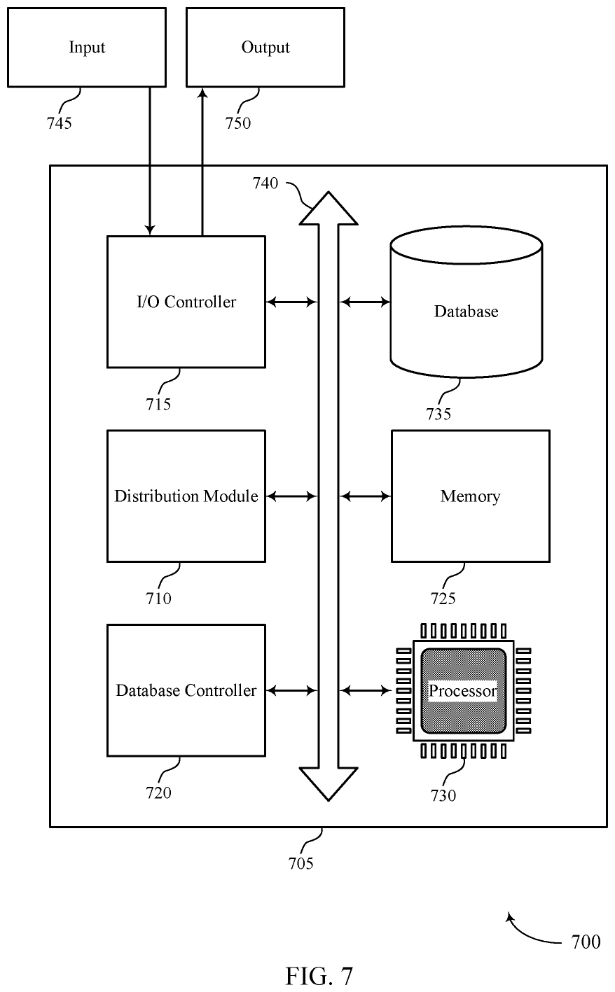

The input module 510 may manage input signals for the apparatus 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the apparatus 505 for processing. For example, the input module 510 may transmit input signals to the distribution module 515 to support FP analysis for distributed systems. In some cases, the input module 510 may be a component of an input/output (I/O) controller 715 as described with reference to FIG. 7.

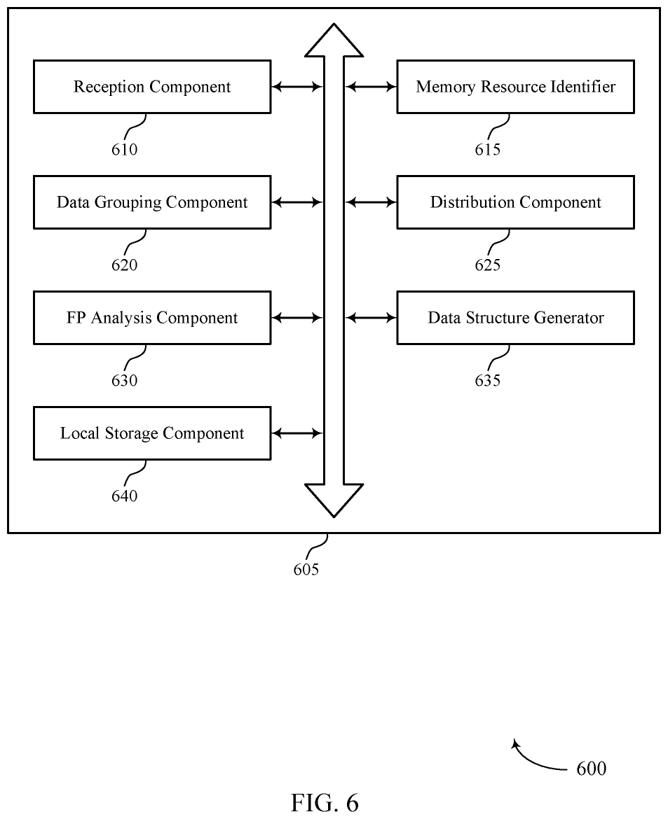

The distribution module 515 may include a reception component 520, a memory resource identifier 525, a data grouping component 530, a distribution component 535, and an FP analysis component 540. The distribution module 515 may be an example of aspects of the distribution module 605 or 710 described with reference to FIGS. 6 and 7.

The distribution module 515 and/or at least some of its various sub-components may be implemented in hardware, software executed by a processor, firmware, or any combination thereof. If implemented in software executed by a processor, the functions of the distribution module 515 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The distribution module 515 and/or at least some of its various sub-components may be physically located at various positions, including being distributed such that portions of functions are implemented at different physical locations by one or more physical devices. In some examples, the distribution module 515 and/or at least some of its various sub-components may be a separate and distinct component in accordance with various aspects of the present disclosure. In other examples, the distribution module 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The reception component 520 may receive, at the database system (e.g., the apparatus 505), a data set for FP analysis, the data set including a set of data objects, where each of the set of data objects includes a number of data attributes. In some cases, the reception component 520 may be an aspect or component of the input module 510.

The memory resource identifier 525 may identify available memory resource capabilities for a set of data processing machines in the database system. In some cases, the memory resource identifier 525 may additionally identify available processing resource capabilities for the set of data processing machines.

The data grouping component 530 may group the set of data objects into a set of data subsets, where the grouping is based on the number of data attributes for each of the set of data objects and the identified available memory resource capabilities.

The distribution component 535 may distribute the set of data objects to the set of data processing machines, where each data processing machine of the set of data processing machines receives one data subset of the set of data subsets. The FP analysis component 540 may perform, separately at each data processing machine of the set of data processing machines, an FP analysis procedure on the received one data subset of the data subsets.

The output module 545 may manage output signals for the apparatus 505. For example, the output module 545 may receive signals from other components of the apparatus 505, such as the distribution module 515, and may transmit these signals to other components or devices. In some specific examples, the output module 545 may transmit output signals for display in a user interface, for storage in a database or data store, for further processing at a server or server cluster, or for any other processes at any number of devices or systems. In some cases, the output module 545 may be a component of an I/O controller 715 as described with reference to FIG. 7.

FIG. 6 shows a block diagram 600 of a distribution module 605 that supports FP analysis for distributed systems in accordance with aspects of the present disclosure. The distribution module 605 may be an example of aspects of a distribution module 515 or a distribution module 710 described herein. The distribution module 605 may include a reception component 610, a memory resource identifier 615, a data grouping component 620, a distribution component 625, an FP analysis component 630, a data structure generator 635, and a local storage component 640. Each of these modules may communicate, directly or indirectly, with one another (e.g., via one or more buses).

The reception component 610 may receive, at the database system, a data set for FP analysis, the data set including a set of data objects, where each of the set of data objects includes a number of data attributes. In some cases, the reception component 610 may additionally receive, at the database system, an updated data set for FP analysis based on a pseudo-realtime FP analysis procedure. In some examples, the set of data objects may include users, sets of users, user devices, sets of user devices, or a combination thereof. Additionally or alternatively, the data attributes may correspond to activities performed by a data object, parameters of the activities performed by the data object, characteristics of the data object, or a combination thereof. In some examples, the data attributes include binary values.

The memory resource identifier 615 may identify available memory resource capabilities for a set of data processing machines in the database system. In some cases, the set of data processing machines may include virtual machines, containers, database servers, server clusters, or a combination thereof. The memory resource identifier 615 may spin up the set of data processing machines for the FP analysis based on the identified available memory resource capabilities. In some cases, if the distribution module 605 supports a pseudo-realtime FP analysis procedure, the memory resource identifier 615 may identify updated available memory resource capabilities for the set of data processing machines in the database system and may determine whether to spin up one or more additional data processing machines of the database system based on the identified updated available memory resource capabilities and a size of a received updated data set for the pseudo-realtime FP analysis procedure. A pseudo-realtime procedure may correspond to a “live” procedure (e.g., with updates occurring below a certain time interval threshold such that the procedure may appear to be constantly updating) or any procedure that updates periodically, semi-periodically, or aperiodically.

In some cases, identifying the available memory resource capabilities for the set of data processing machines involves the memory resource identifier 615 transmitting a set of memory resource capability requests to the set of data processing machines and receiving, from each data processing machine of the set of data processing machines, a respective indication of available memory resources for each data processing machine. In some examples, the memory resource identifier 615 may transmit a superset of memory resource capability requests to a superset of data processing machines, receive, from each data processing machine of the superset of data processing machines, a respective indication of available memory resources for each data processing machine of the superset of data processing machines, and select the set of data processing machines for the FP analysis based on the indications of available memory resources for the set of data processing machines.

In other cases, the memory resource identifier 615 may identify the available memory resource capabilities for the set of data processing machines by estimating available memory resources at the set of data processing machines based on a type of each data processing machine of the set of data processing machines, other processes running on each data processing machine of the set of data processing machines, other data stored at each data processing machine of the set of data processing machines, or a combination thereof.

The data grouping component 620 may group the set of data objects into a set of data subsets, where the grouping is based on the number of data attributes for each of the set of data objects and the identified available memory resource capabilities. In some cases, the grouping involves the data grouping component 620 determining a frequency of occurrence for each data attribute, where the grouping is based on the determined frequency of occurrence for each data attribute. Additionally or alternatively, each data subset of the set of data subsets may include either a number of data objects that is less than a data object threshold or a number of data attributes for each data object of the data subset that is less than a data attribute threshold.

The distribution component 625 may distribute the set of data objects to the set of data processing machines, where each data processing machine of the set of data processing machines receives one data subset of the set of data subsets.

The FP analysis component 630 may perform, separately at each data processing machine of the set of data processing machines, an FP analysis procedure on the received one data subset of the set of data subsets.

The data structure generator 635 may generate (e.g., as part of the FP analysis procedure), at each data processing machine of the set of data processing machines, a condensed data structure including an FP-tree and a linked list corresponding to the received one data subset of the set of data subsets.

The local storage component 640 may store, in local memory for each data processing machine of the set of data processing machines, the condensed data structure. In some cases, the FP analysis component 630 may perform, locally at each data processing machine of the set of data processing machines, an FP mining procedure on the condensed data structure stored by the local storage component 640. The FP analysis component 630 may identify, at each data processing machine of the set of data processing machines, a set of FPs as a result of the FP mining procedure.

In some cases, the reception component 610 may receive, at the database system and from a user device, a user request indicating a data attribute for analysis, where the FP mining procedure is performed based on the user request. The FP analysis component 630 may transmit, to the user device and in response to the user request, an FP associated with the indicated data attribute for analysis based on the FP mining procedure. Additionally or alternatively, the FP analysis component 630 may transmit, from each data processing machine of the set of data processing machines, the set of FPs for storage at a database.

FIG. 7 shows a diagram of a system 700 including a device 705 that supports FP analysis for distributed systems in accordance with aspects of the present disclosure. The device 705 may be an example of or include the components of a database system or an apparatus 505 as described herein. The device 705 may include components for bi-directional data communications including components for transmitting and receiving communications, including a distribution module 710, an I/O controller 715, a database controller 720, memory 725, a processor 730, and a database 735. These components may be in electronic communication via one or more buses (e.g., bus 740).

The distribution module 710 may be an example of a distribution module 515 or 605 as described herein. For example, the distribution module 710 may perform any of the methods or processes described herein with reference to FIGS. 5 and 6. In some cases, the distribution module 710 may be implemented in hardware, software executed by a processor, firmware, or any combination thereof.

The I/O controller 715 may manage input signals 745 and output signals 750 for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The database controller 720 may manage data storage and processing in a database 735. In some cases, a user may interact with the database controller 720. In other cases, the database controller 720 may operate automatically without user interaction. The database 735 may be an example of a single database, a distributed database, multiple distributed databases, a data store, a data lake, or an emergency backup database.

Memory 725 may include RAM and read-only memory (ROM). The memory 725 may store computer-readable, computer-executable software including instructions that, when executed, cause the processor to perform various functions described herein. In some cases, the memory 725 may contain, among other things, a basic input/output system (BIOS) which may control basic hardware or software operation such as the interaction with peripheral components or devices.

The processor 730 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting FP analysis for distributed systems).

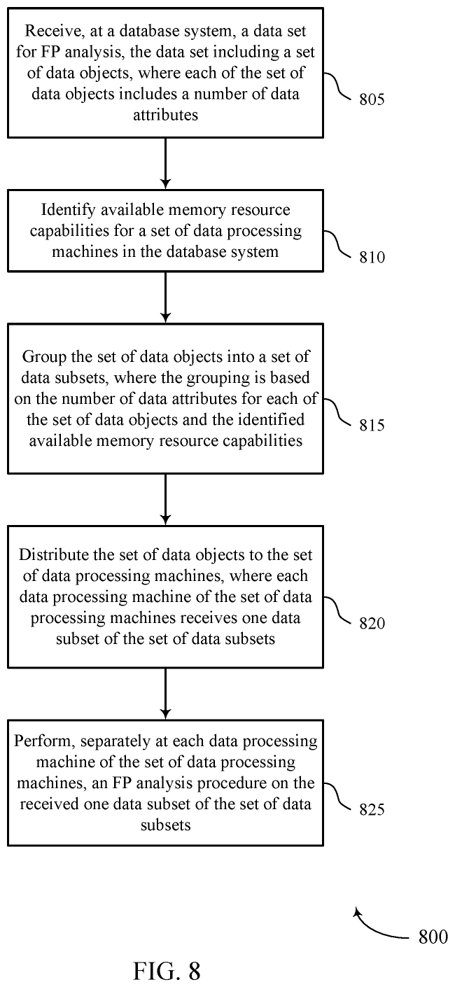

FIG. 8 shows a flowchart illustrating a method 800 that supports FP analysis for distributed systems in accordance with aspects of the present disclosure. The operations of method 800 may be implemented by a database system or its components as described herein. For example, the operations of method 800 may be performed by a distribution module as described with reference to FIGS. 5 through 7. In some examples, a database system may execute a set of instructions to control the functional elements of the database system to perform the functions described herein. Additionally or alternatively, a database system may perform aspects of the functions described herein using special-purpose hardware.

At 805, the database system may receive a data set for FP analysis, the data set including a set of data objects, where each of the set of data objects includes a number of data attributes. The operations of 805 may be performed according to the methods described herein. In some examples, aspects of the operations of 805 may be performed by a reception component as described with reference to FIGS. 5 through 7.

At 810, the database system may identify available memory resource capabilities for a set of data processing machines in the database system. The operations of 810 may be performed according to the methods described herein. In some examples, aspects of the operations of 810 may be performed by a memory resource identifier as described with reference to FIGS. 5 through 7.

At 815, the database system may group the set of data objects into a set of data subsets, where the grouping is based on the number of data attributes for each of the set of data objects and the identified available memory resource capabilities. The operations of 815 may be performed according to the methods described herein. In some examples, aspects of the operations of 815 may be performed by a data grouping component as described with reference to FIGS. 5 through 7.

At 820, the database system may distribute the set of data objects to the set of data processing machines, where each data processing machine of the set of data processing machines receives one data subset of the set of data subsets. The operations of 820 may be performed according to the methods described herein. In some examples, aspects of the operations of 820 may be performed by a distribution component as described with reference to FIGS. 5 through 7.

At 825, the database system may perform, separately at each data processing machine of the set of data processing machines, an FP analysis procedure on the received one data subset of the set of data subsets. The operations of 825 may be performed according to the methods described herein. In some examples, aspects of the operations of 825 may be performed by an FP analysis component as described with reference to FIGS. 5 through 7.

A method for FP analysis at a database system is described. The method may include receiving, at the database system, a data set for FP analysis, the data set including a set of data objects, where each of the set of data objects includes a number of data attributes, identifying available memory resource capabilities for a set of data processing machines in the database system, and grouping the set of data objects into a set of data subsets, where the grouping is based on the number of data attributes for each of the set of data objects and the identified available memory resource capabilities. The method may further include distributing the set of data objects to the set of data processing machines, where each data processing machine of the set of data processing machines receives one data subset of the set of data subsets, and performing, separately at each data processing machine of the set of data processing machines, an FP analysis procedure on the received one data subset of the set of data subsets.

An apparatus for FP analysis at a database system is described. The apparatus may include a processor, memory in electronic communication with the processor, and instructions stored in the memory. The instructions may be executable by the processor to cause the apparatus to receive, at the database system, a data set for FP analysis, the data set including a set of data objects, where each of the set of data objects includes a number of data attributes, identify available memory resource capabilities for a set of data processing machines in the database system, and group the set of data objects into a set of data subsets, where the grouping is based on the number of data attributes for each of the set of data objects and the identified available memory resource capabilities. The instructions may be further executable by the processor to cause the apparatus to distribute the set of data objects to the set of data processing machines, where each data processing machine of the set of data processing machines receives one data subset of the set of data subsets, and perform, separately at each data processing machine of the set of data processing machines, an FP analysis procedure on the received one data subset of the set of data subsets.

Another apparatus for FP analysis at a database system is described. The apparatus may include means for receiving, at the database system, a data set for FP analysis, the data set including a set of data objects, where each of the set of data objects includes a number of data attributes, identifying available memory resource capabilities for a set of data processing machines in the database system, and grouping the set of data objects into a set of data subsets, where the grouping is based on the number of data attributes for each of the set of data objects and the identified available memory resource capabilities. The apparatus may further include means for distributing the set of data objects to the set of data processing machines, where each data processing machine of the set of data processing machines receives one data subset of the set of data subsets, and performing, separately at each data processing machine of the set of data processing machines, an FP analysis procedure on the received one data subset of the set of data subsets.

A non-transitory computer-readable medium storing code for FP analysis at a database system is described. The code may include instructions executable by a processor to receive, at the database system, a data set for FP analysis, the data set including a set of data objects, where each of the set of data objects includes a number of data attributes, identify available memory resource capabilities for a set of data processing machines in the database system, and group the set of data objects into a set of data subsets, where the grouping is based on the number of data attributes for each of the set of data objects and the identified available memory resource capabilities. The code may further include instructions executable by the processor to distribute the set of data objects to the set of data processing machines, where each data processing machine of the set of data processing machines receives one data subset of the set of data subsets, and perform, separately at each data processing machine of the set of data processing machines, an FP analysis procedure on the received one data subset of the set of data subsets.

In some examples of the method, apparatuses, and non-transitory computer-readable medium described herein, performing the FP analysis procedure separately at each data processing machine of the set of data processing machines may include operations, features, means, or instructions for generating, at each data processing machine of the set of data processing machines, a condensed data structure including an FP-tree and a linked list corresponding to the received one data subset of the set of data subsets and storing, in local memory for each data processing machine of the set of data processing machines, the condensed data structure.

In some examples of the method, apparatuses, and non-transitory computer-readable medium described herein, performing the FP analysis procedure separately at each data processing machine of the set of data processing machines may include operations, features, means, or instructions for performing, locally at each data processing machine of the set of data processing machines, an FP mining procedure on the condensed data structure and identifying, at each data processing machine of the set of data processing machines, a set of FPs as a result of the FP mining procedure.

Some examples of the method, apparatuses, and non-transitory computer-readable medium described herein may further include operations, features, means, or instructions for receiving, at the database system and from a user device, a user request indicating a data attribute for analysis, where the FP mining procedure is performed based on the user request. Some examples of the method, apparatuses, and non-transitory computer-readable medium described herein may further include operations, features, means, or instructions for transmitting, to the user device and in response to the user request, an FP associated with the indicated data attribute for analysis based on the FP mining procedure.

Some examples of the method, apparatuses, and non-transitory computer-readable medium described herein may further include operations, features, means, or instructions for transmitting, from each data processing machine of the set of data processing machines, the set of FPs for storage at a database.

In some examples of the method, apparatuses, and non-transitory computer-readable medium described herein, grouping the set of data objects into the set of data subsets may include operations, features, means, or instructions for determining a frequency of occurrence for each data attribute, where the grouping is based on the determined frequency of occurrence for each data attribute.

In some examples of the method, apparatuses, and non-transitory computer-readable medium described herein, each data subset of the set of data subsets includes either a number of data objects that may be less than a data object threshold or a number of data attributes for each data object of the data subset that may be less than a data attribute threshold.

In some examples of the method, apparatuses, and non-transitory computer-readable medium described herein, identifying the available memory resource capabilities for the set of data processing machines may include operations, features, means, or instructions for transmitting a set of memory resource capability requests to the set of data processing machines and receiving, from each data processing machine of the set of data processing machines, a respective indication of available memory resources for each data processing machine of the set of data processing machines.

In some examples of the method, apparatuses, and non-transitory computer-readable medium described herein, transmitting the set of memory resource capability requests to the set of data processing machines may include operations, features, means, or instructions for transmitting a superset of memory resource capability requests to a superset of data processing machines and receiving, from each data processing machine of the superset of data processing machines, a respective indication of available memory resources for each data processing machine of the superset of data processing machines. Some examples of the method, apparatuses, and non-transitory computer-readable medium described herein may further include operations, features, means, or instructions for selecting the set of data processing machines for the FP analysis based on the indications of available memory resources for the set of data processing machines.

In some examples of the method, apparatuses, and non-transitory computer-readable medium described herein, identifying the available memory resource capabilities for the set of data processing machines may include operations, features, means, or instructions for estimating available memory resources at the set of data processing machines based on a type of each data processing machine of the set of data processing machines, other processes running on each data processing machine of the set of data processing machines, other data stored at each data processing machine of the set of data processing machines, or a combination thereof.

Some examples of the method, apparatuses, and non-transitory computer-readable medium described herein may further include operations, features, means, or instructions for spinning up the set of data processing machines for the FP analysis based on the identified available memory resource capabilities.

Some examples of the method, apparatuses, and non-transitory computer-readable medium described herein may further include operations, features, means, or instructions for receiving, at the database system, an updated data set for FP analysis based on a pseudo-realtime FP analysis procedure and identifying updated available memory resource capabilities for the set of data processing machines in the database system. Some examples of the method, apparatuses, and non-transitory computer-readable medium described herein may further include operations, features, means, or instructions for determining whether to spin up one or more additional data processing machines of the database system based on the identified updated available memory resource capabilities and a size of the updated data set.

In some examples of the method, apparatuses, and non-transitory computer-readable medium described herein, the set of data processing machines includes virtual machines, containers, database servers, server clusters, or a combination thereof

In some examples of the method, apparatuses, and non-transitory computer-readable medium described herein, the set of data objects includes users, sets of users, user devices, sets of user devices, or a combination thereof. In some examples of the method, apparatuses, and non-transitory computer-readable medium described herein, the data attributes correspond to activities performed by a data object, parameters of the activities performed by the data object, characteristics of the data object, or a combination thereof. In some examples of the method, apparatuses, and non-transitory computer-readable medium described herein, the data attributes are examples of binary values.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for frequent pattern (FP) analysis at a database system, comprising:
receiving, at the database system, a data set for FP analysis, the data set comprising a plurality of data objects, wherein each of the plurality of data objects comprises a number of data attributes;
identifying available memory resource capabilities for a plurality of data processing machines in the database system;
grouping the plurality of data objects into a plurality of data subsets, wherein the grouping is based at least in part on the number of data attributes for each of the plurality of data objects and the identified available memory resource capabilities;
distributing the plurality of data objects to the plurality of data processing machines, wherein each data processing machine of the plurality of data processing machines receives one data subset of the plurality of data subsets; and
performing, separately at each data processing machine of the plurality of data processing machines, an FP analysis procedure on the received one data subset of the plurality of data subsets.

2. The method of claim 1, wherein performing the FP analysis procedure separately at each data processing machine of the plurality of data processing machines comprises:
generating, at each data processing machine of the plurality of data processing machines, a condensed data structure comprising an FP-tree and a linked list corresponding to the received one data subset of the plurality of data subsets; and
storing, in local memory for each data processing machine of the plurality of data processing machines, the condensed data structure.

3. The method of claim 2, wherein performing the FP analysis procedure separately at each data processing machine of the plurality of data processing machines further comprises:
performing, locally at each data processing machine of the plurality of data processing machines, an FP mining procedure on the condensed data structure; and
identifying, at each data processing machine of the plurality of data processing machines, a set of FPs as a result of the FP mining procedure.

4. The method of claim 3, further comprising:
receiving, at the database system and from a user device, a user request indicating a data attribute for analysis, wherein the FP mining procedure is performed based at least in part on the user request; and
transmitting, to the user device and in response to the user request, an FP associated with the indicated data attribute for analysis based at least in part on the FP mining procedure.

5. The method of claim 3, further comprising:
transmitting, from each data processing machine of the plurality of data processing machines, the set of FPs for storage at a database.

6. The method of claim 1, wherein grouping the plurality of data objects into the plurality of data subsets further comprises:
determining a frequency of occurrence for each data attribute, wherein the grouping is based at least in part on the determined frequency of occurrence for each data attribute.

7. The method of claim 1, wherein each data subset of the plurality of data subsets comprises either a number of data objects that is less than a data object threshold or a number of data attributes for each data object of the data subset that is less than a data attribute threshold.

8. The method of claim 1, wherein identifying the available memory resource capabilities for the plurality of data processing machines comprises:
transmitting a plurality of memory resource capability requests to the plurality of data processing machines; and
receiving, from each data processing machine of the plurality of data processing machines, a respective indication of available memory resources for each data processing machine of the plurality of data processing machines.

9. The method of claim 8, wherein transmitting the plurality of memory resource capability requests to the plurality of data processing machines further comprises:
transmitting a superset of memory resource capability requests to a superset of data processing machines;
receiving, from each data processing machine of the superset of data processing machines, a respective indication of available memory resources for each data processing machine of the superset of data processing machines; and
selecting the plurality of data processing machines for the FP analysis based at least in part on the indications of available memory resources for the plurality of data processing machines.

10. The method of claim 1, wherein identifying the available memory resource capabilities for the plurality of data processing machines comprises:
estimating available memory resources at the plurality of data processing machines based at least in part on a type of each data processing machine of the plurality of data processing machines, other processes running on each data processing machine of the plurality of data processing machines, other data stored at each data processing machine of the plurality of data processing machines, or a combination thereof.

11. The method of claim 1, further comprising:
spinning up the plurality of data processing machines for the FP analysis based at least in part on the identified available memory resource capabilities.

12. The method of claim 1, further comprising:
receiving, at the database system, an updated data set for FP analysis based at least in part on a pseudo-realtime FP analysis procedure;
identifying updated available memory resource capabilities for the plurality of data processing machines in the database system; and
determining whether to spin up one or more additional data processing machines of the database system based at least in part on the identified updated available memory resource capabilities and a size of the updated data set.

13. The method of claim 1, wherein the plurality of data processing machines comprises virtual machines, containers, database servers, server clusters, or a combination thereof.

14. The method of claim 1, wherein the plurality of data objects comprises users, sets of users, user devices, sets of user devices, or a combination thereof.

15. The method of claim 1, wherein the data attributes correspond to activities performed by a data object, parameters of the activities performed by the data object, characteristics of the data object, or a combination thereof.

16. The method of claim 15, wherein the data attributes comprise binary values.

17. An apparatus for frequent pattern (FP) analysis at a database system, comprising:
a processor,
memory in electronic communication with the processor; and
instructions stored in the memory and executable by the processor to cause the apparatus to:
receive, at the database system, a data set for FP analysis, the data set comprising a plurality of data objects, wherein each of the plurality of data objects comprises a number of data attributes;
identify available memory resource capabilities for a plurality of data processing machines in the database system;
group the plurality of data objects into a plurality of data subsets, wherein the grouping is based at least in part on the number of data attributes for each of the plurality of data objects and the identified available memory resource capabilities;
distribute the plurality of data objects to the plurality of data processing machines, wherein each data processing machine of the plurality of data processing machines receives one data subset of the plurality of data subsets; and
perform, separately at each data processing machine of the plurality of data processing machines, an FP analysis procedure on the received one data subset of the plurality of data subsets.

18. The apparatus of claim 17, wherein the instructions to perform the FP analysis procedure separately at each data processing machine of the plurality of data processing machines are executable by the processor to cause the apparatus to:
generate, at each data processing machine of the plurality of data processing machines, a condensed data structure comprising an FP-tree and a linked list corresponding to the received one data subset of the plurality of data subsets; and
store, in local memory for each data processing machine of the plurality of data processing machines, the condensed data structure.

19. The apparatus of claim 17, wherein each data subset of the plurality of data subsets comprises either a number of data objects that is less than a data object threshold or a number of data attributes for each data object of the data subset that is less than a data attribute threshold.

20. A non-transitory computer-readable medium storing code for frequent pattern (FP) analysis at a database system, the code comprising instructions executable by a processor to:
receive, at the database system, a data set for FP analysis, the data set comprising a plurality of data objects, wherein each of the plurality of data objects comprises a number of data attributes;
identify available memory resource capabilities for a plurality of data processing machines in the database system;
group the plurality of data objects into a plurality of data subsets, wherein the grouping is based at least in part on the number of data attributes for each of the plurality of data objects and the identified available memory resource capabilities;
distribute the plurality of data objects to the plurality of data processing machines, wherein each data processing machine of the plurality of data processing machines receives one data subset of the plurality of data subsets; and
perform, separately at each data processing machine of the plurality of data processing machines, an FP analysis procedure on the received one data subset of the plurality of data subsets.
